(19) United States
(12) Patent Application Publication
(10) Pub. No.: US 2015/0331948 A1
(43) Pub. Date: Nov. 19, 2015

(54) SEARCH INFRASTRUCTURE AND METHOD FOR PERFORMING WEB SEARCH

(71) Applicant: International Business Machines Corporation, Armonk, NY (US)

(72) Inventors: Andreas Arning, Tuebingen (DE); Stefan Liesche, Boeblingen (DE); Andreas Nauerz, Stuttgart (DE); Andreas Prokoph, Boeblingen (DE); Thomas Stober, Herrenberg (DE)

(21) Appl. No.: 14/691,644

(22) Filed: Apr. 21, 2015

(30) Foreign Application Priority Data
May 19, 2014 (GB) 1408804.1

(51) Int. Cl. G06F 17/30

(52) U.S. Cl. CPC G06F 17/30864; G06F 17/30554

(57) ABSTRACT

Aspects of the present invention disclose a method, computer program product, and system for managing web searching. The method includes one or more processors tracking user activity on the at least one website. The method further includes one or more processors analyzing the tracked user activity on the at least one website. The method further includes one or more processors generating a user profile based on the tracked user activity on the at least one website. The method further includes one or more processors mapping the generated user profile and corresponding user identity information between one or more of: a search service provider, an analytic service provider, and a provider of the at least one website. The method further includes one or more processors storing the generated user profile.

### CROSS-REFERENCE TO RELATED APPLICATION

This application claims priority under 35 U.S.C. §119 to United Kingdom Patent Application No. 1408804.1 filed May 19, 2014, the entire contents of which are incorporated herein by reference.

### BACKGROUND OF THE INVENTION

The present invention relates in general to the field of web search, and in particular to a search infrastructure for performing a web search, and a corresponding method for performing a web search. Still more particularly, the present invention relates to a data processing program and a computer program product for performing a web search.

Known Internet search engines return search results in a ranking order, which is based on the relevance of the identified websites for a certain search string. This relevance is based on rules defined by the search engine provider. The rules take into account characteristics of the crawled website. Each user will receive the same search results for a given search string. There might be exceptions to this, if the search engine provider uses analytics techniques to display personalized content, maybe even advertisement. For instance the search engine provider can learn from analytics which links of the search result page a user is clicking, and which keywords a user is asking for. This allows the search engine provider to deduct patterns and behavior and preferences the search engine provider could also use to tailor the ranking of the search results.

### SUMMARY

Aspects of the present invention disclose a method, computer program product, and system for managing web searching. The method includes one or more processors tracking user activity on the at least one web site. The method further includes one or more processors analyzing the tracked user activity on the at least one website. The method further includes one or more processors generating a user profile based on the tracked user activity on the at least one website. The method further includes one or more processors mapping the generated user profile and corresponding user identity information between one or more of: a search service provider, an analytic service provider, and a provider of the at least one website. The method further includes one or more processors storing the generated user profile. In an additional aspect of the present invention, the method further includes one or more processors receiving a search query input by a first user, wherein the first user is associated with the generated user profile and the corresponding user identity information, and one or more processors optimizing search results that correspond to the received search query based on the generated user profile.

### BRIEF DESCRIPTION OF THE DRAWINGS

A preferred embodiment of the present invention, as described in detail below, is shown in the drawings, in which:

FIG. 1 is a schematic diagram of a method for performing a web search, in accordance with an embodiment of the present invention;

FIG. 2 is a schematic generic block diagram of a search infrastructure, in accordance with an embodiment of the present invention;

FIG. 3 is a more detailed block diagram of the search infrastructure of FIG. 2, in accordance with a first embodiment of the present invention; and

FIG. 4 is a more detailed block diagram of the search infrastructure of FIG. 2, in accordance with a second embodiment of the present invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The technical problem underlying the present invention is to provide a search infrastructure and a corresponding method for performing a web search, which are able to improve the search results for individuals and communities.

According to the present invention, this problem is solved by providing a search infrastructure for performing a web search, a method for performing a web search, a data processing program for performing a web search, and a computer program product for performing a web search.

Accordingly, in an embodiment of the present invention a search infrastructure for performing a web search by a user client system comprises at least one independent search service provider, at least one independent analytics service provider, and means for mapping user identity data and user profile information between the at least one search service provider, the at least one analytics service provider, and at least one independent website provider providing at least one website. The search service provider comprises at least means for receiving search queries; and means for optimizing search results by consuming analytics data provided by the at least one analytics service provider. The at least one analytics service provider comprises at least means for tracking user activities on the at least one website; and means for generating a user profile based on analyzing user activities on the at least one website. The mapping means provide authorized access to the user profile information to the at least one search service provider or the at least one analytics service provider for optimizing the web search for the associated user.

In further embodiments of the present invention, the means for analyzing user activities on the at least one website extract user behavior and create history data of the user behavior used for generating the user profile.

In further embodiments of the present invention, the user profile information is placed at least by one of the following entities: the user client system, the analytics service provider, the search service provider, or a trusted authority.

In further embodiments of the present invention, the trusted authority performs mapping of the user identity data and the user profile information.

In further embodiments of the present invention, the user identity data is based on a cookie or an openID account.

In further embodiments of the present invention, the at least one analytics provider monitors search queries of the user and activities the user performs on returned search results, where monitoring results are merged into the user profile information.

In another embodiment of the present invention, a method for performing a web search comprises the steps of: tracking user activities on at least one website; analyzing user activities on the at least one website; generating and storing a user profile based on the user activities on the at least one website; providing authorized access to user profile data for optimizing a web search for an associated user; mapping user identity data and user profile information between independent search service provider and independent analytics service provider and independent website provider; using the user profile data for optimizing the web search for an associated user.

In further embodiments of the present invention, the user activities on the at least one website are analyzed to extract user behavior and to create history data of the user behavior used for generating the user profile.

In further embodiments of the present invention, the search queries of a user and activities of the user performed on returned search results are monitored.

In further embodiments of the present invention, the monitoring results are merged into the user profile information.

In further embodiments of the present invention, the user profile data is used to optimize a search query inputted by the user.

In further embodiments of the present invention, the user profile data is used to optimize search results outputted to the user.

In further embodiments of the present invention, the search results are filtered based on the user profile data and an optimized search result is outputted to the user.

In another embodiment of the present invention, a data processing program for execution in a data processing system comprises software code portions for performing a method for performing a web search when the program is run on the data processing system.

In yet another embodiment of the present invention, a computer program product stored on a computer-usable medium, comprises computer readable program means for causing a computer to perform a method for performing a web search when the program is run on the computer.

Additional embodiments of the present invention increase the involvement of analytics in a web search and offer a highly customized and/or personalized search for individuals and communities. Various embodiments of the present invention utilize the exchange of information and/or cooperation between the search engine provider and analytic providers and provider of the web pages that are being found. For example, the user searches using the search engine of a search service provider and clicks on a link returned by the search engine. The user leaves the search engine site and accesses the “found” website. The analytics provider can monitor the behavior of the user on the “found” website, e.g., did the user “like” the page and stay long and/or bookmark that page and/or tag content on that page, etc. Certain habits can map implicitly to the relevance of this web page for this particular user. The analytics provider can send that “user specific relevance information” back to the search engine. The search engine can reflect this user-specific feedback for future search results and their ranking. The search engine could also reflect this feedback for future search results of the other users, e.g., with similar interests, within the same community, etc.

Further, embodiments of the present invention utilize intelligent decoupling between a user and/or a website and analytics service provider and search engine.

Embodiments of the present invention can accomplish the exchange of information between a search engine and other websites and the analytics provider by open interfaces. A user can be identified uniquely across multiple websites and search engines, e.g., through an openID identification or via cookies.

In summary, to improve the short comings and problems of prior art solutions analytics provider can be decoupled from the search provider, and the user can specify which search provider and analytics provider is allowed to use his user activity data (e.g., openID account). The search results can be improved based on user profile information, wherein a third party identifier (e.g., opened) could be used. The analytics provider has access to a website provider via browser plugins; OpenID account etc., for example.

The above, as well as additional purposes, features, and advantages of the present invention will become apparent in the following detailed written description.

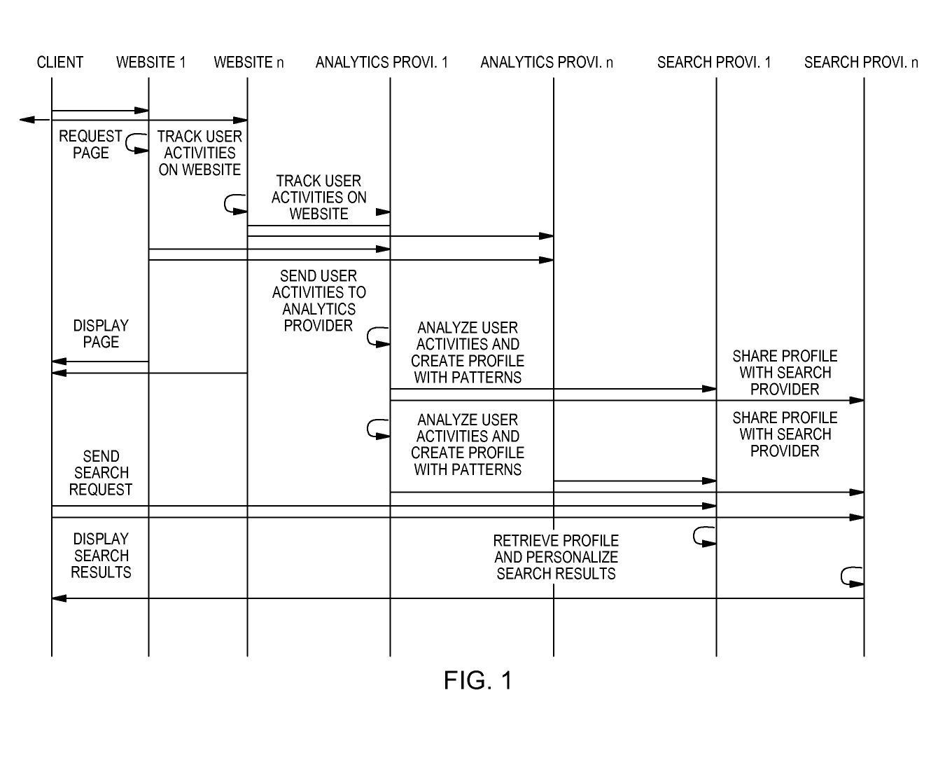

FIG. 1 shows a method for performing a web search, in accordance with an embodiment of the present invention. Referring to FIG. 1, the shown embodiment of the present invention employs a method for performing a web search, wherein the user requests or visits different independent websites, denoted as Website 1 and Website n. The user does not have to access or utilize search engine configurations or analytics providers in order to utilize a website. An analytics service provider, denoted as Analytics Prov. 1 and Analytics Prov. n, can have an API (Application Programming Interface) contract with multiple independent websites. The analytics service provider can provide analytics services to the websites based on the data retrieved from the website. In addition, the analytics service provider can offer the analytics results to one or multiple search service providers, denoted as Search Prov. 1 and Search Prov. n. Each search service provider can also work with one or multiple analytics providers. Search providers can retrieve analytics results through a defined API. The search providers use that data to build user specific behavioral patterns. A user can be uniquely identified across the different players, through various mechanisms, e.g., an open ID account, tracking cookie, etc.

The user is capable of accessing any of the participating search providers and submit search requests. Since the search providers have background knowledge of the user, the search providers can provide much more targeted search results. Based on the generic interfaces and the decoupling the optimized search can cover a broad range of websites, which are collaborating with different independent analytics providers and different search providers. If the openID account is used to identify the user, the data the user has stored in the openID account can be used to offer the user a personalized search experience. This can be done when opening the search user interface, even before leveraging any analytics insights.

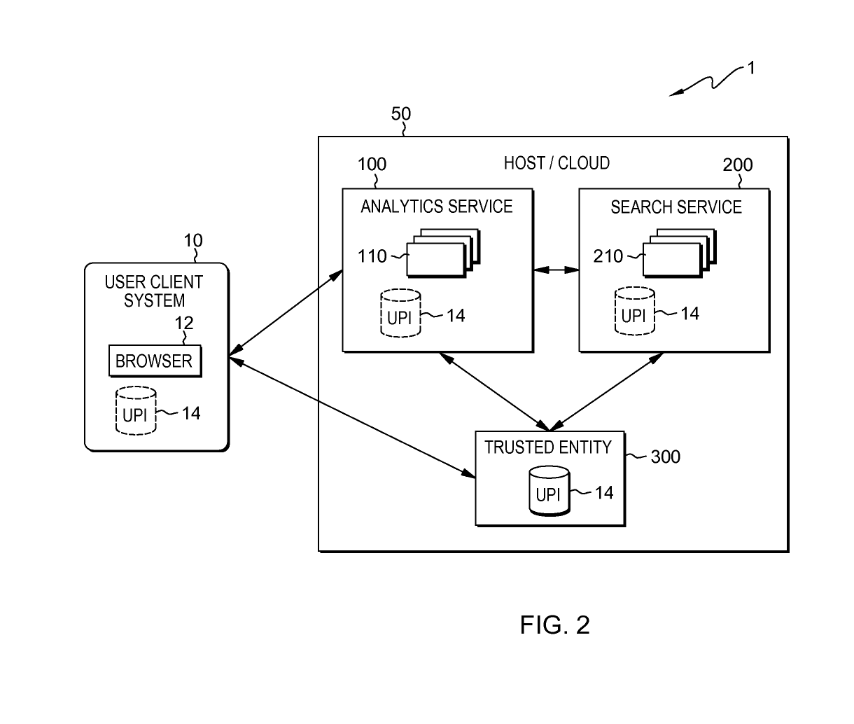

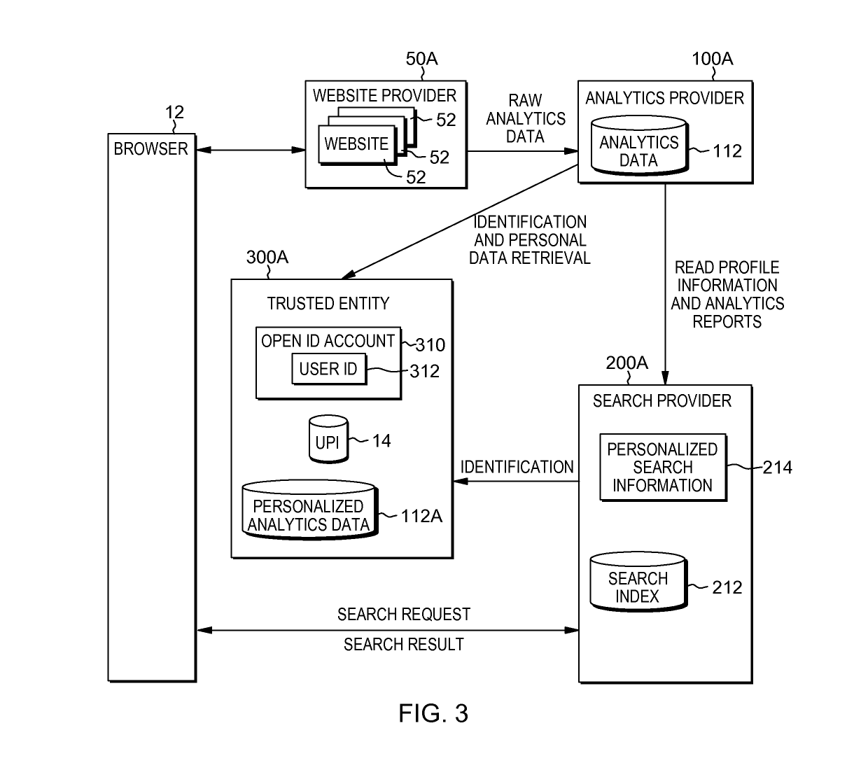

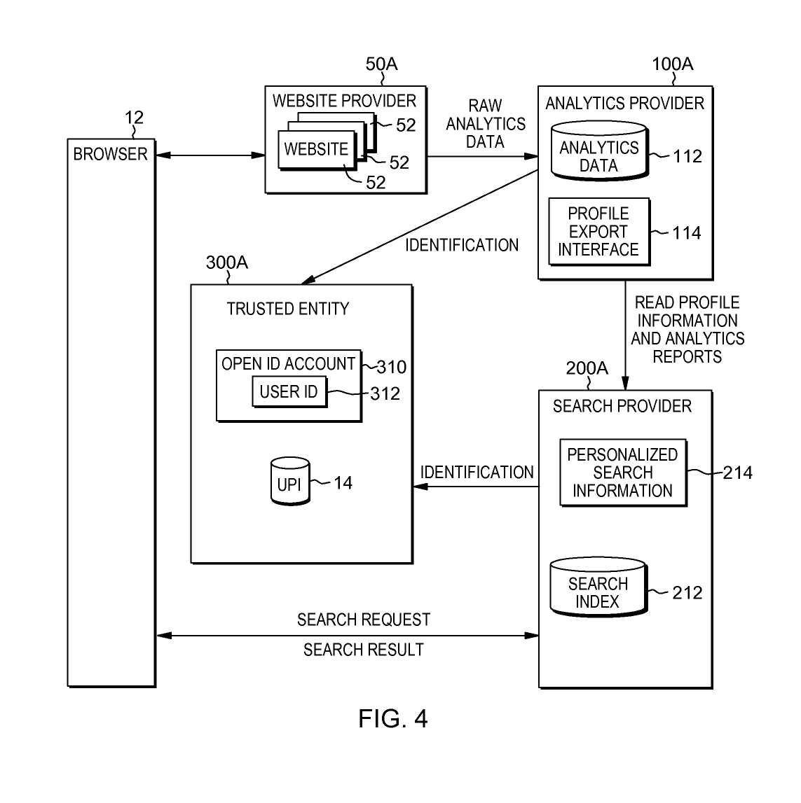

FIG. 2 shows a generic search infrastructure, in accordance with an embodiment of the present invention. FIG. 3 shows a more detailed depiction of the search infrastructure of FIG. 2, in accordance with a first embodiment of the present invention. FIG. 4 shows a more detailed depiction of the search infrastructure of FIG. 2, in accordance with a second embodiment of the present invention.

Referring to FIGS. 2 to 4, search infrastructure 1 is depicted for performing a web search by user client system 10 (e.g., on host/cloud 50) that comprises at least one independent instance of search service provider 200 (depicted in FIG. 2 as search service 200), at least one independent instance of analytics service provider 100 (depicted in FIG. 2 as analytics service 100), and trusted entity 300 (e.g., a mapping means) for mapping user identity data (e.g., user ID 312) and user profile information (UPI) 14 between the at least one instance of search service provider 200. The at least one instance of analytics service provider 100, and at least one independent instance of website provider 50A provide at least one website 52. Search service provider 200 comprises at least means 210 for receiving search queries, and means for optimizing personalized search information 214 and search index 212 (e.g., search results) by consuming analytics data 112 provided by the at least one instance of analytics service provider 100. The at least one instance of analytics service provider 100 comprises at least means 110 for tracking user activities on the at least one instance of website 52 and for generating user profile information 14 based on analyzing user activities on the at least one instance of website 52. Trusted entity 300 provides authorized access of user profile information 14 to at least search service provider 200 or analytics service provider 100 for optimizing the web search for the associated user.

Variations of the present invention operate to utilize the actual storage location of the behavioral user data, which comprises user profile information 14, and/or personalized analytics data 112A, and/or personalized search information 214. One option is to allow search service provider 200 and/or 200A to retrieve user data from analytics service provider 100 and/or 100A and store the retrieved user data on the user's premise as personalized search information 214 (e.s., and also a reference in search index 212). In this case, analytics service provider 100 and/or 100A and search service provider 200 and/or 200A have full ownership of the user's behavioral data. Another option is that search service provider 200 and/or 200A retrieves the user data as personalized search information 214 on each search request directly from the analytics service provider 100 and/or 100A without storing the data locally. In this case, only analytics service provider 100 and/or 100A may have full ownership of the user's behavioral data. A third option is shown in FIG. 3, in which data is stored as user profile information 14 and personalized analytics data 112A, independent from analytics service provider 100 and/or 100A and search service provider 200 and/or 200A. Trusted entity 300 and/or 300A may be a neutral location, such as a user's profile (e.g., user ID 312) within a corresponding instance of openID account 310. Trusted entity 300 and/or 300A (e.g., identification providers) manage openID accounts 310. In this case, trusted entity 300 and/or 300A (e.g., a third party) may own the user's behavioral data and grant selected data to other parties for optimizing the results of a current request. A fourth variation is shown in FIG. 4, in which the user's behavioral data is stored as profile export interface 114 at the analytics service provider 100 and/or 100A, and as personalized search information 214 at the search service provider 200 and/or 200A in an anonymized way. The trusted third party authentication system (e.g., open ID account, trusted entity 300 and/or 300A, etc.) can map the identification, which is not disclosed to the other parties.

As ownership of data is a sensible topic, the trusted entity variations can become important considerations. Decoupling of the parties allows for managing ownership of a user's personal behavioral data directly by the user. The proposed system can be configured by the user in a transparent way, e.g., it can be agreed that the user specifies (e.g., in his open ID profile), which instance of analytics service provider 100 and/or 100A and which instance of search service provider 200 and/or 200A is allowed to use the user's behavioral data. For example, the user can configure to share the data only with a first search engine but not with a second search engine. Further, the user can grant core metrics the right to share analytics data but not other providers. This configuration can be enforced at the generic APIs, which decouple website 52, analytics service provider 100 and/or 100A, and search service provider 200 and/or 200A. For example, a specific API can require a certificate granted by the actual user, or a callback to the configuration within an OpenID account of the actual user. The trusted openID service can block providers that do not comply with the defined privacy and data ownership policies. In this case, a trusted openID provider (e.g., trusted entity 300 and/or 300A) can manage and/or grant a trusted relationship, and the trusted relationship may not be under the control of analytics service provider 100 and/or 100A nor search service provider 200 and/or 200A.

To enable analytics service provider 100 and/or 100A, each monitored instance of website 52 collects the activities that the user performs. A common approach is to inject a script (e.g., HTML code, etc.) into the web page, which aggregates the events, such as “button 1 clicked,” and sends the list of events to the analytics service provider 100 and/or 100A. This approach is also known as active site analytics. Analytics service provider 100 and/or 100A analyzes the events to identify usage patterns. Usage patterns of a particular user will map the user into profile categories. For example, mapping user activities and/or patterns into profile information can be accomplished utilizing an open source library. The resulting user profile can be accessed by a partnering search service, such as search service provider 200 and/or 200A. In various examples, analytics service provider 100 and/or 100A and search service provider 200 and/or 200A can both identify either using a cookie or an openID account, such as openID account 310. Trusted entity 300 and/or 300A ensures that the user activities that are profiled can be mapped to the same person that will request a search later on. In addition, analytics service provider 100 and/or 100A can also monitor the search queries of the user, and the activities that the user performs on the returned search results, e.g., spend 10 minutes focused reading on one particular result, while the user skips another result immediately. This information can be merged into the overall profiling, which is performed by analytics service provider 100 and/or 100A.

Search service provider 200 and/or 200A can fetch the user profiles from a partnering analytics provider, such as analytics service provider 100 and/or 100A. Once a user sends a search request to search service provider 200 and/or 200A, search service provider 200 and/or 200A associates the request to the corresponding profile, e.g., based on cookie or openID. The search results are be filtered based on the profile before the search results are sent to the user. The filtering can be done in several ways. Facets of the user's profile data can be a suitable approach in this context.

The communication between user client system 10 and/or browser 12 and websites 52 as well as the search service provider 200 and/or 200A are normal HTTP requests and/or responses without any changes, wherein a unique user identification based on a cookie or an openID account is used. The communication between user client system 10 and/or browser 12 and websites 52 and analytics service provider 100 and/or 100A can be accomplished based on best practices, e.g., applying active site analytics, which capture user activities on an arbitrary website using programming scripts (e.g., HTML code, etc.) and sending the gathered information to an analytics server. The communication between analytics service provider 100 and/or 100A and search service provider 200 and/or 200A can be accomplished utilizing several methods, as long as both parties agree on a common approach. Typically, search service provider 200 and/or 200A can fetch the user profile data from an analytics server using a REST service call.

Still referring to FIGS. 2 to 4, analytics service provider 100 and/or 100A analyzes user activities on the at least one instance of website 52, extracts user behavior and creates history data of the user behavior used for generating the user profile information 14. The user profile information 14 is placed at the user client system 10, and/or the analytics service provider 100 and/or 100A, and/or the search service provider 200 and/or 200A, and/or to the trusted entity 300 and/or 300A. Trusted entity 300 and/or 300A performs mapping of the user identity data (e.g., user ID 312) and said user profile information 14, wherein the user identity data (e.g., user ID 312) is based on a cookie or an openID account, as described above. Further, at least one instance of analytics service provider 100 and/or 100A monitors search queries of the user and activities the user performs on returned search results, where monitoring results are merged into the user profile information 14.

Embodiments of the method for performing a web search comprise the steps of: tracking user activities on at least one instance of website 52; analyzing user activities on the at least one instance of web site 52; generating and storing a user profile information 14 based on the user activities on the at least one instance of website 52; providing authorized access to user profile information 14 for optimizing a web search for an associated user; mapping user identity data (e.g., user ID 312) and user profile information 14 between an independent instance of search service provider 200 and an independent instance of analytics service provider 100 and an independent instance of website provider 50A; and using the user profile information 14 for optimizing the web search for an associated user. User profile information 14 can be used to optimize a search query input by the user. Alternatively, user profile information 14 can be used to optimize search results output to the user.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing web searching, the method comprising:
tracking, by one or more processors, user activity on the at least one website;
analyzing, by one or more processors, the tracked user activity on the at least one website;
generating, by one or more processors, a user profile based on the tracked user activity on the at least one website;
mapping, by one or more processors, the generated user profile and corresponding user identity information between one or more of: a search service provider, an analytic service provider, and a provider of the at least one website; and
storing, by one or more processors, the generated user profile.

2. The method of claim 1, further comprising:
receiving, by one or more processors, a search query input by a first user, wherein the first user is associated with the generated user profile and the corresponding user identity information; and
optimizing, by one or more processors, search results that correspond to the received search query based on the generated user profile.

3. The method of claim 1, wherein analyzing the tracked user activity on the at least one website, further comprises:
creating, by one or more processors, user history information based on extracting user activity on the at least one website.

4. The method of claim 2, further comprising:
monitoring, by one or more processors, search queries input by the first user; and
monitoring, by one or more processors, activity performed by the first user on search results returned in response to the monitored search queries.

5. The method of claim 4, further comprising:
merging, by one or more processors, the monitored activity performed by the first user into the generated user profile.

6. The method of claim 2, wherein optimizing search results that correspond to the received search query based on the generated user profile, further comprises:
filtering, by one or more processors, the search results based on the generated user profile.

7. The method of claim 2, further comprising:
initiating, by one or more processors, display of the optimized search results that correspond to the received search query to the first user.

8. A computer program product for managing web searching, the computer program product comprising:
one or more computer readable storage media and program instructions stored on the one or more computer readable storage media, the program instructions comprising:
program instructions to track user activity on the at least one website;
program instructions to analyze the tracked user activity on the at least one website;
program instructions to generate a user profile based on the tracked user activity on the at least one website;
program instructions to map the generated user profile and corresponding user identity information between one or more of: a search service provider, an analytic service provider, and a provider of the at least one website; and
program instructions to store the generated user profile.

9. The computer program product of claim 8, further comprising program instructions, stored on the one or more computer readable storage media, to:
receive a search query input by a first user, wherein the first user is associated with the generated user profile and the corresponding user identity information; and
optimize search results that correspond to the received search query based on the generated user profile.

10. The computer program product of claim 8, wherein the program instructions to analyze the tracked user activity on the at least one website further comprise program instructions to:
create user history information based on extracting user activity on the at least one website.

11. The computer program product of claim 9, further comprising program instructions, stored on the one or more computer readable storage media, to:
monitor search queries input by the first user; and
monitor activity performed by the first user on search results returned in response to the monitored search queries.

12. The computer program product of claim 11, further comprising program instructions, stored on the one or more computer readable storage media, to:
merge the monitored activity performed by the first user into the generated user profile.

13. The computer program product of claim 9, wherein the program instructions to optimize search results that correspond to the received search query based on the generated user profile further comprise program instructions to:
filter the search results based on the generated user profile.

14. The computer program product of claim 9, further comprising program instructions, stored on the one or more computer readable storage media, to:
initiate display of the optimized search results that correspond to the received search query to the first user.

15. A computer system for managing web searching, the computer system comprising:
one or more computer processors;
one or more computer readable storage media; and
program instructions stored on the computer readable storage media for execution by at least one of the one or more processors, the program instructions comprising:
program instructions to track user activity on the at least one website;
program instructions to analyze the tracked user activity on the at least one website;
program instructions to generate a user profile based on the tracked user activity on the at least one website;
program instructions to map the generated user profile and corresponding user identity information between one or more of: a search service provider, an analytic service provider, and a provider of the at least one website; and
program instructions to store the generated user profile.

16. The computer system of claim 15, further comprising program instructions, stored on the computer readable storage media for execution by at least one of the one or more processors, to:
receive a search query input by a first user, wherein the first user is associated with the generated user profile and the corresponding user identity information; and
optimize search results that correspond to the received search query based on the generated user profile.

17. The computer system of claim 15, wherein the program instructions to analyze the tracked user activity on the at least one website further comprise program instructions to:
create user history information based on extracting user activity on the at least one website.

18. The computer system of claim 16, further comprising program instructions, stored on the computer readable storage media for execution by at least one of the one or more processors, to:
monitor search queries input by the first user; and
monitor activity performed by the first user on search results returned in response to the monitored search queries.

19. The computer system of claim 18, further comprising program instructions, stored on the computer readable storage media for execution by at least one of the one or more processors, to:
merge the monitored activity performed by the first user into the generated user profile.

20. The computer system of claim 16, wherein the program instructions to optimize search results that correspond to the received search query based on the generated user profile further comprise program instructions to:
filter the search results based on the generated user profile.
